(19) United States
(12) Patent Application Publication
(10) Pub. No.: US 2012/0193311 A1
(43) Pub. Date: Aug. 2, 2012

(54) AISLE VIOLATING DISPLAY FOR ADORNING RETAIL SHELVING SYSTEMS

(75) Inventor: Patrick Benasillo, Staten Island, NY (US)

(73) Assignee: Visual Graphic Systems, Inc., New York, NY (US)

(21) Appl. No.: 13/019,274

(22) Filed: Feb. 1, 2011

(51) Int. Cl. A47F 1/04; B23P 17/04

(52) U.S. Cl. 211/59.2; 29/525.01

(57) ABSTRACT

An aisle violating display is configured to be attached to a vertically oriented structural member, such as conventional upright shelving.

### TECHNICAL FIELD

The present invention relates to merchandizing display assemblies and in particular, to a merchandise fixture, such as an aisle violating display, for attachment to a vertically oriented structural member, such as conventional upright shelving.

### BACKGROUND

Retail sales improve when the merchandise is easy to touch and feel and therefore there is an art to presenting merchandise to the public. Merchandise fixtures and accessories are designed to not only provide a support surface (e.g., shelving) for the products but are also designed to utilize every inch of space with interesting, eye-catching presentations with a goal of increasing sales.

The nature of merchandise displays may range somewhat from industry to industry, but all merchandise fixtures/displays are predicated on basic principles designed to increase product purchases. Indeed, merchandise displays are an integral element of the overall merchandising concept, which seeks to promote product sales by coordinating marketing, advertising, and sales strategies. Typically, merchandise fixtures are upstanding structures that are placed within the store in a side-by-side and opposing manner so as to define aisles in the store. Each merchandise fixture includes shelves or the like on which the product is placed.

A merchandise display system can also include aisle violators which are a great way to draw customers' attention to featured promotions or products. An aisle violator is a structure that can be attached to an existing merchandise fixture and extends outwardly into the store aisle. The aisle violator provides surface areas that are typically decorated with product related information and indicia so as to draw the attention of the consumer to a particular featured product. Aisle violators can also serve to separate one product from another product.

Merchandise fixtures are typically modular based assemblies in that upright shelving typically includes an upstanding back wall with shelving attached thereto and extending outwardly through in a perpendicular manner to form planar surfaces that receive and support product.

There is a need for alternative, improved merchandise displays and in particular, for an improved assembly and method for affixing an aisle violator to an upstanding merchandise display.

### SUMMARY

A merchandise display includes an upstanding shelving display including a frame with perforated vertical support members; and an aisle violator merchandise display assembly for attachment to the shelving display. The aisle violator merchandise display assembly includes first and second vertical support members. Each vertical support member having a plurality of longitudinal channels formed therein and along a length thereof. Each channel is defined by a lip having an underside surface. The first and second vertical supports are spaced apart from one another and parallel to one another. The assembly also includes at least one cross bar that is attached at its ends to the spaced vertical supports. Each end of the cross bar has a deployable locking member in the form of a pair of locking fingers the distance between which can be varied by an actuator that is part of the cross bar. The locking fingers in a fully deployed position are locked within one channel and caught underneath the underside surface thereof.

The assembly also includes a plurality of connectors that are attached at their ends to one of the spaced vertical supports and to the perforated frame of the merchandise display. Each end of the connector has a deployable locking member in the form of a pair of locking fingers the distance between which can be varied by an actuator that is part of the connector. The locking fingers at a first end of the connector in a fully deployed position are locked within one channel and caught underneath the underside surface thereof. The locking fingers at the other end for are captured within one opening formed in the perforated vertical support member for attaching the aisle violator merchandise display assembly to the upstanding shelving display.

These and other aspects, features and advantages shall be apparent from the accompanying Drawings and description of certain embodiments of the invention.

### BRIEF DESCRIPTION OF THE DRAWINGS

FIG. 1 is a front and side perspective view of an aisle violating display according to one embodiment of the present invention shown affixed to upright shelving;

FIG. 2 is a side view of the display and shelving assembly of FIG. 1 showing an aisle violator in the form of a banner;

FIG. 3 is another side view of the display and shelving assembly of FIG. 1 showing an aisle violator in the form of a magnetic add on member;

FIG. 4 is a front view of the display and shelving assembly of FIG. 1;

FIG. 5 is cross-sectional view through a vertical support of the aisle violating display;

FIG. 6 is perspective view of one end of a connector with a deployable locking member;

FIG. 7 is a perspective view of the vertical support with grip inserts inserted into a channel formed therein;

FIG. 8 is an end perspective view of a leveling foot being inserted into one end of the vertical support;

FIG. 9 is a front perspective view showing installation of one vertical support to the merchandise display;

FIG. 10 is a perspective view showing locking of one end of the connector to the merchandise display frame;

FIG. 11 is a perspective view showing locking of the other end of the connector to the frame of the aisle violator assembly;

FIG. 12 is a perspective view showing locking of ends of the connector to the merchandise display frame and the frame of the aisle violator assembly;

FIG. 13 is side view showing attachment of a display sign to the merchandise display frame;

FIG. 14 is a side view showing attachment of a display sign to the merchandise display frame;

FIG. 15 is a side perspective view showing locking of ends of the connector to the merchandise display frame and the frame of the aisle violator assembly in an middle location;

FIG. 16 shows the locking of the connector end;

FIG. 17 is side perspective of a graphic display being installed;

FIGS. 18 and 19 show locking of cross bars using deployable locking members and installation of a graphic header; and

FIG. 20 is a side view showing a display bridge that is attached to an extends between two opposing aisle violating displays that are opposite one another in an aisle.

### DETAILED DESCRIPTION OF CERTAIN EMBODIMENTS OF THE INVENTION

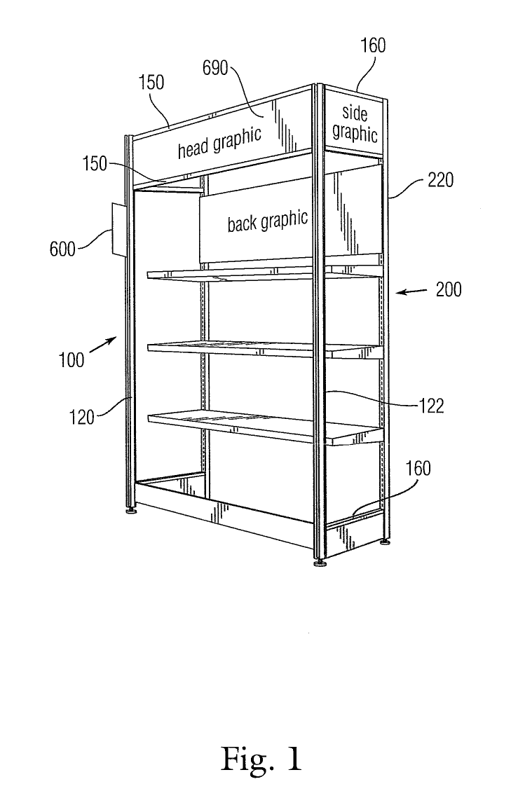

FIG. 1 is a perspective view of an aisle violating display 100 for attachment to and existing merchandise display 200. The illustrated merchandise display 200 is in the form of conventional upright shelving. The merchandise display 200 thus is formed of a base 210 and an upstanding frame 220 that is attached to the base 210. The base 210 is the ground contacting portion that rests on the ground of the store and is typically, rectangular in shape. However, the base 210 can be formed to have any number of other shapes. The base 210 includes a top surface 212 on which items can be displayed. The top surface 212 of the base 210 thus represents the bottommost shelf of the display.

The frame 220 at least includes first and second vertical frame members 222, 224 that are attached first ends to the base 210. The first and second vertical frame members 222, 224 are spaced apart from one another and are parallel to one another. In order to permit shelving 300 to be easily attached to the frame 220, the first and second vertical frame members 222, 224 have openings or slots 230 formed therein that receive complementary hooks or the like that are part of the shelving 300 to allow the shelving 300 to be fully supported and depend from the frame 220. In the illustrated embodiment, there is a plurality of shelves 300 mounted to the frame 220 above the base 210. The locations of the shelving 300 can be adjusted by simply locking the hooks of the shelves 300 into other sets of openings 230. Each shelf 300 provides a planar support surface 302 that receives products.

The merchandise display 200 can optionally include a backing member in the form of a back wall 231 that is attached to at least one of the base 210 and the frame 220. The back wall 231 can be a perforated structure, such as peg board or the like.

The above-described merchandise display 200 is of conventional design and therefore, suffers from associated disadvantages in that it is difficult to add and attach other merchandise accessories, such as an aisle violator, to the frame 220.

The aisle violating display 100 of the present invention overcomes the disadvantages associated with the prior art and provides a display assembly that can be easily attached to existing conventional merchandise displays, such as the upright shelving 200, and provides a frame for mounting aisle violators and other merchandise display accessories.

The aisle violating display 100 includes a frame 110 that is formed of a number of individual components, as described herein, that mate together to form frame 110 and provide a means for attaching the frame 110 to the merchandise display 200 and more specifically, to the frame 220 thereof. The frame 110 includes first and second elongated vertical supports 120, 122 that each has a first end 124 and an opposing second end 126. The vertical supports 120, 122 are oriented in a spaced relation and parallel to one another.

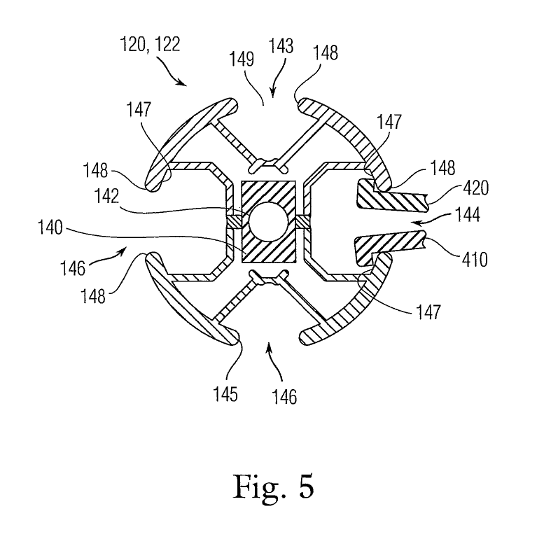

The first ends 124 are ground contacting structures and therefore, preferably include a protective/leveling foot 130 or the like. For example and as shown in FIG. 5, the first end 124 can include a central core 140 that has a threaded bore 142 that receives a threaded leveling foot 130. The vertical support 120, 122 is a multi-channeled structure in that it includes a plurality of longitudinally extending channels that extend at least substantially from the first end 124 to the second end 126. In the illustrated embodiment, the vertical support 120, 122 includes four spaced apart channels, namely, a first channel 143, a second channel 144, a third channel 145, and a fourth channel 146. The four channels are approximately spaced 90 degrees apart from one another. Each channel is defined by a lip 148 that is actually formed of two opposing flanges that spaced apart by a slot 149 that defines an entrance into the channel. The flanges provide underside mounting surfaces 147 that are described in more detail below.

It will be appreciated that the vertical supports 120, 122 can be elongated extruded parts formed of rigid plastic or metal.

The frame 110 also includes at least one main upper cross bar 150 that extends between and is securely attached to the vertical supports 120, 122. In the illustrated embodiment, there are two upper cross bars 150 that are oriented parallel to one another and parallel to the ground. One cross bar 150 is attached to the vertical supports 120, 122 at or near the second ends 126 thereof, while the other cross bar 150 is spaced below.

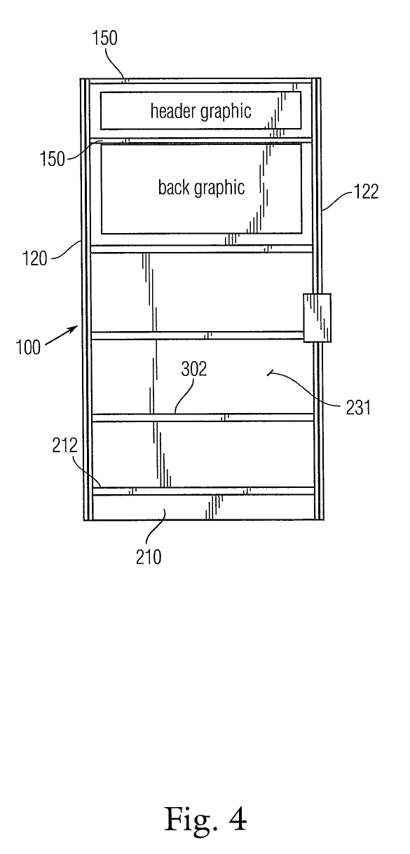

The cross bars 150 thus not only provide structural support to the frame 110 but also the space between the two cross bars 150 can be used to as a media display surface in that at advertisement or other information can be displayed using a sign or the like that extends between the two cross bars 150 as shown in FIG. 4. This signage can be referred to as the header graphic 690 of the display 100.

The frame 110 also includes connectors 160 that are used to securely attach the frame 110 to the merchandise display 200 and more specifically, the frame 220 thereof. In accordance with the present invention, the connectors 160 are elongated support members that are designed to be complementary to and to mate with both the vertical supports 120, 122 and the frame 220 of the merchandise display 200 so as to provide easy yet secure attachment of the display 100 to the merchandise display 200. As shown in the figures, typically, at least four connectors 160 are used to attach the frame 110 to the frame 220 and more specifically, two connectors 160 are used at a bottom portion (near first ends 124) of the vertical supports 120, 122 to anchor a bottom portion of the frame 110 to the display 200 and two connectors 160 are used at a top portion (near second ends 126) to anchor a top portion of the frame 110 to the frame 220.

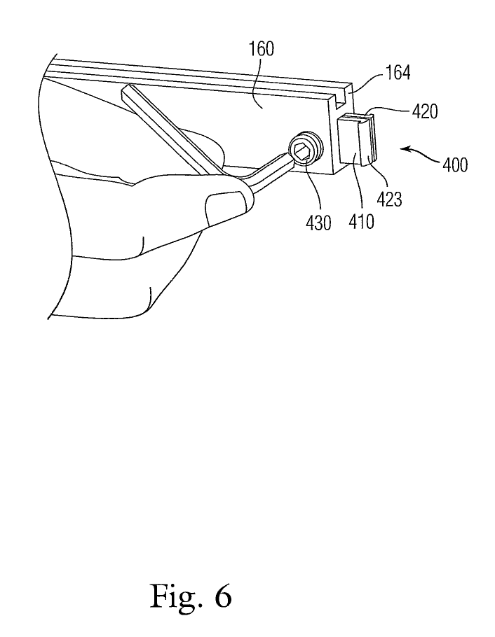

The connector 160 has a first end 162 and an opposing second end 164. At each end 162, 164, the connector includes a deployable locking member or clip (catch) 400 that is designed to engage and lock with both the vertical support 120, 122 and the frame 220. FIG. 6 shows the deployable locking member 400.

The deployable locking member 400 includes a first part 410 and a second part 420. The first and second parts 410, 420 are preferably mirror images of one another and include a finger portion with a locking rib or ridge 423 formed at an end thereof. The locking rib 423 is angled and is complementary to both the channels 143, 144, 145, 146 and the openings 230 of the first and second vertical frame members 222, 224 as described below.

Any number of different mechanical means for deploying the locking member 400 can be used to deploy and retract the locking member 400. For example, an actuator, such as a drive screw, 430 can be used. The actuator 430 is coupled to the first and second parts 410, 420 such that rotation of the actuator (screw) causes the first and second parts 410, 420 to separate from one another, while rotation in an opposite direction causes the first and second parts 410, 420 to move toward one another. In the illustrated embodiment, an allen wrench is used to rotate the drive screw 430.

In yet another embodiment, one of the first and second parts 410, 420 is fixed, while the other is coupled to the drive screw 430 such that rotation of the drive screw causes the coupled part 410, 420 to move relative to the fixed part. Continued rotation causes greater separation and similarly, rotation in an opposite direction results in the movable part 410, 420 moving back toward the fixed part 410, 420.

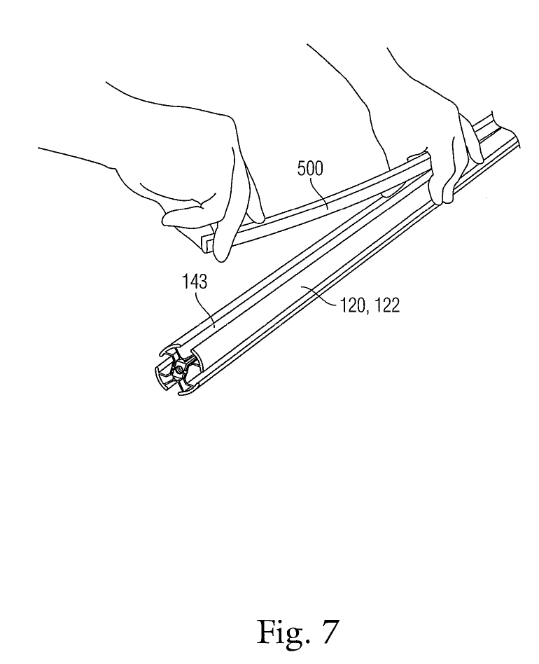

The method of attaching the display 100 to the merchandise display 200 is now described. Vertical supports 120, 122 are provided and the user positions grip inserts 500 into a select number of channels 143, 144, 145, 146. The grip inserts 500, as shown in FIG. 7, have a central longitudinal channel or slot defined therein for receiving a member, such as an aisle violator 600. The shape and resilient nature of the grip insert 500 permits it to be retainingly held within the channel 143, 144, 145, 146. In particular, the grip insert 500 is shaped so that it is caught under (along the underside) the flanges that define the channel 143, 144, 145, 146. At least one of the channels 143, 144, 145, 146 does not receive a grip insert 500.

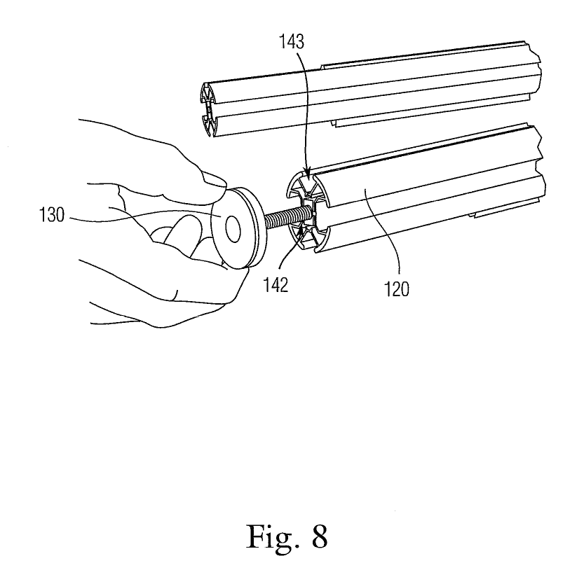

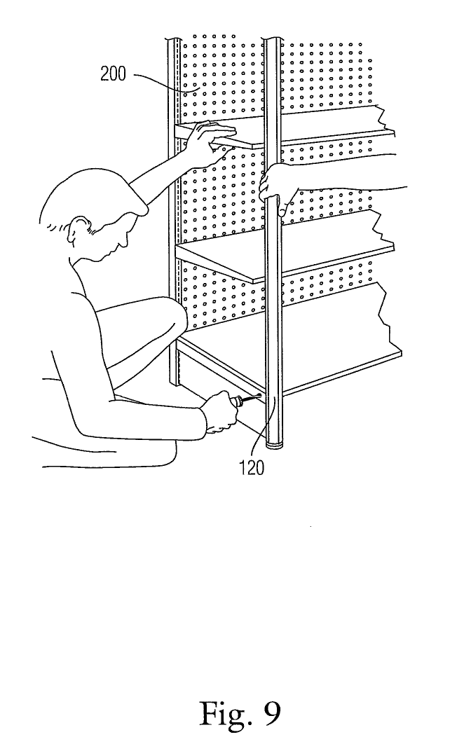

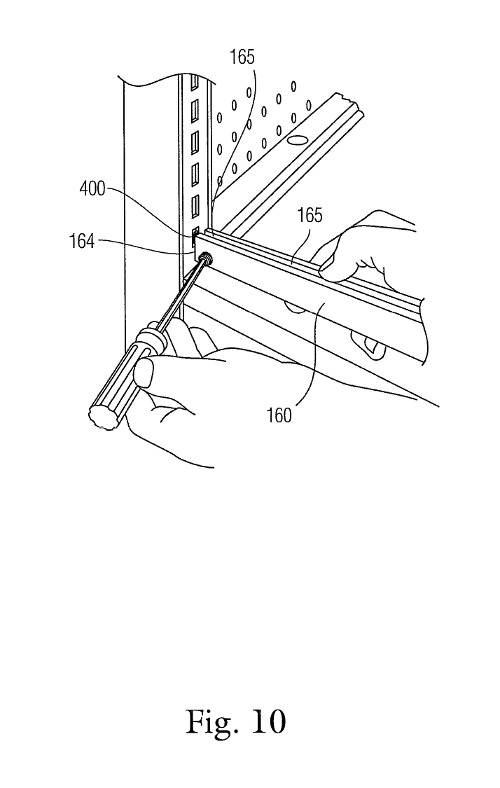

FIG. 8 shows the foot 130 being screwed into the threaded bore 142. FIG. 9 shows the vertical support 120 being placed at one corner of the merchandise display 200 with the channel 143 that does not contain the grip insert 500 facing backward to the rear of the display 200. Next as shown in FIG. 10, the end 164 of the connector 160 and in particular, the locking member 400 thereat is inserted into one opening 130. An open slot 165 that is formed as part of the connector 160 faces up. The actuator 430 is then manipulated causing the first and second parts 410, 420 to separate within the opening 130 and this results in the locking ridges 423 being captured on an underside of the wall in which the opening 130 is formed. The deployed locking member 400 thus securely attaches the connector end 164 to the frame 220 by using the existing openings 130.

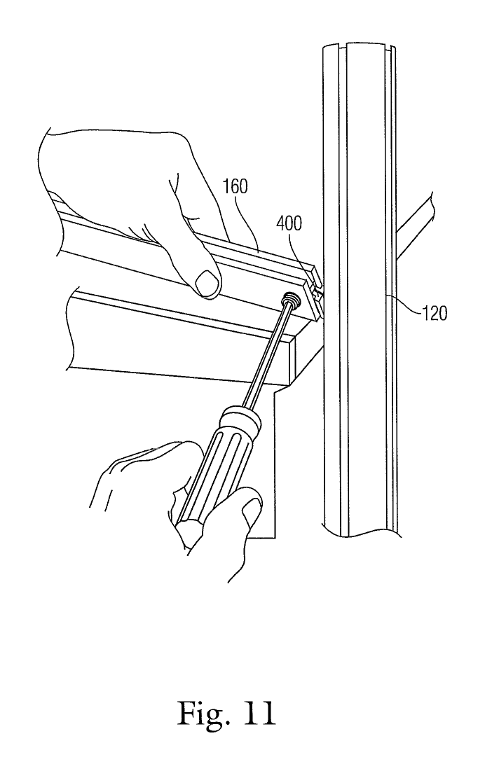

FIG. 11 shows the other end 162 of the connector 160 being inserted into the open, rearwardly facing channel 143 of the vertical support 120. The actuator 430 is then manipulated causing the first and second parts 410, 420 to separate within the channel and this results in the locking ridges 423 being captured on an underside of the lip 148 (along surfaces 147). The deployed locking member 400 thus securely attaches the connector end 162 to the vertical support 120.

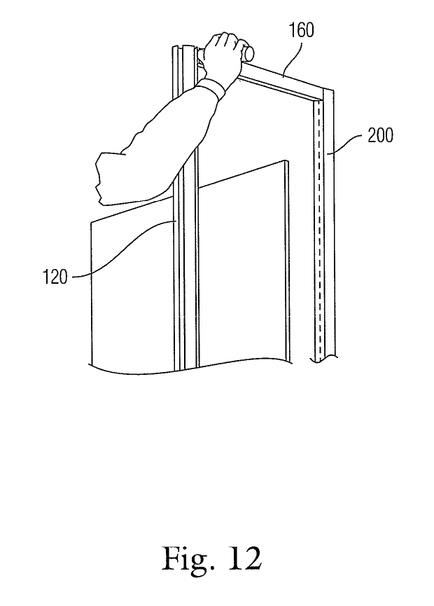

FIG. 12 shows the same steps of FIGS. 10-11 being repeated at the top with the open slot 165 of the connector 160 facing down. This results in a connector 160 being attaching between the support 120 and frame 220 at the top of the display 200.

The same steps are performed for attaching the other vertical support 122 to the other front corner of the display. This results in the four connectors 160 being attached between the frame 110 and frame 220.

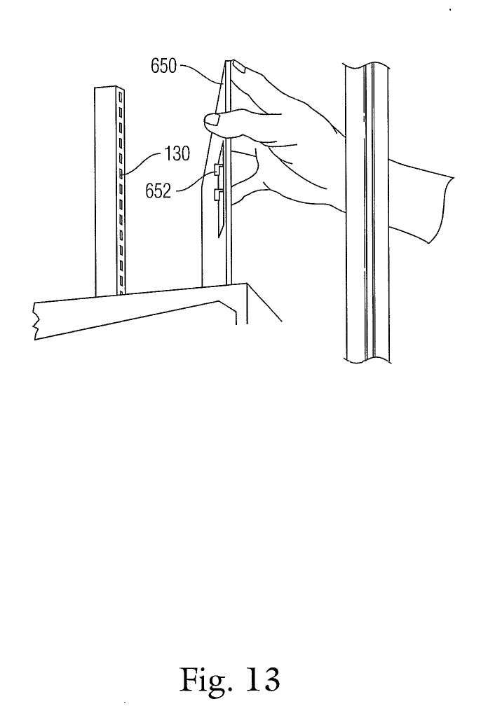

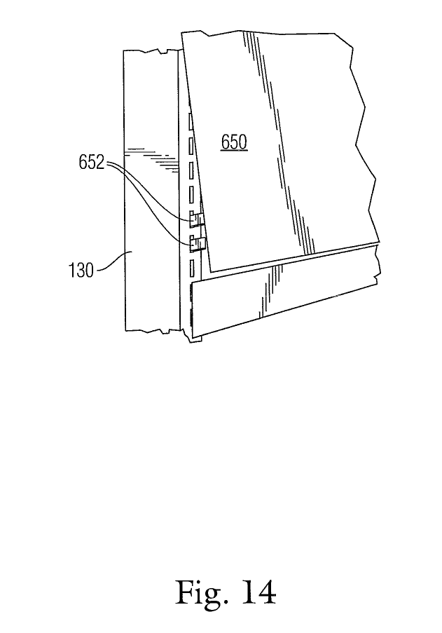

FIG. 13 shows a graphic panel 650 with clips 652 being placed on a top shelf of the display 200. FIG. 14 shows the panel 650 being slid into openings 130 and secured using clips 652.

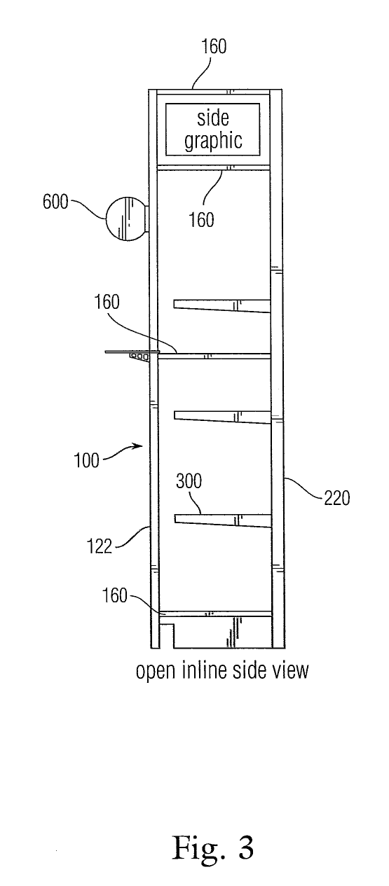

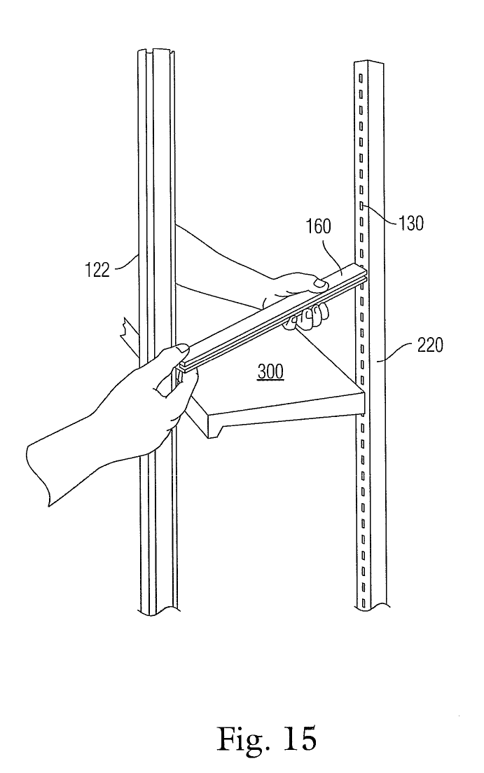

FIG. 15 shows an optional use of connector 160 in a middle portion as shown in FIG. 3. In this embodiment, the connector 160 is disposed with the open slot 165 facing up for split graphic display and additional connector facing down for the bottom display.

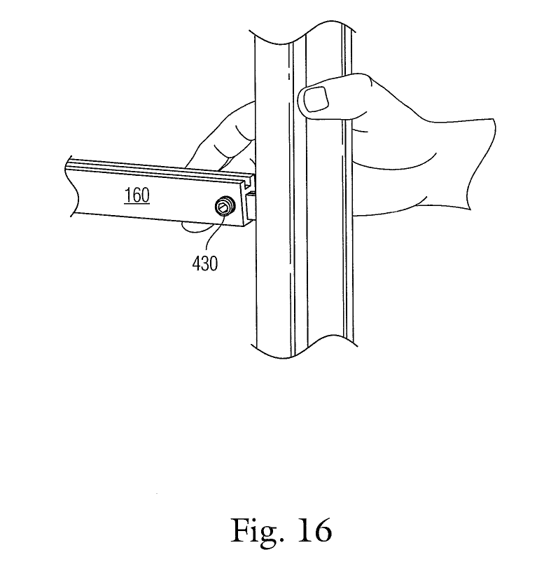

FIG. 16 shows the height of the graphic panel 675 being measures and then the ends 162, 164 of the connector 160 are attached to the frames 110, 220 using the deployable locking members 400 in the manner described above. The top graphic panel 675 is then inserted into the slot 165 and secured with a top connector 160 as shown. Thus, the top graphic panel 675 is received with the downward facing slot 165 of the top connector 160 and the upward facing slot 165 of the bottom connector 160.

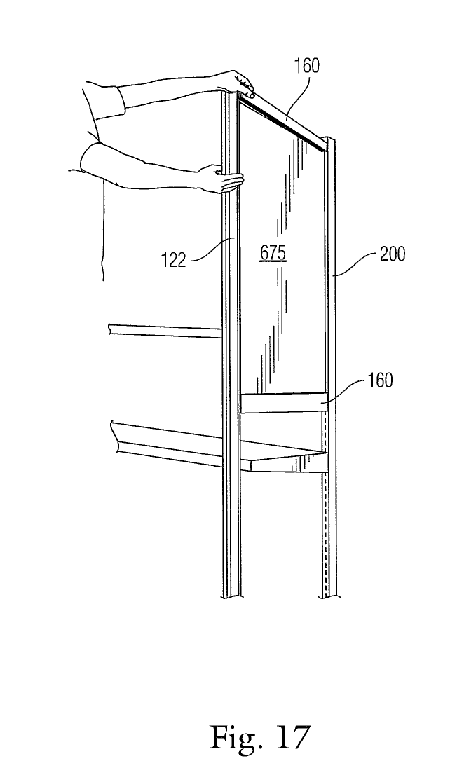

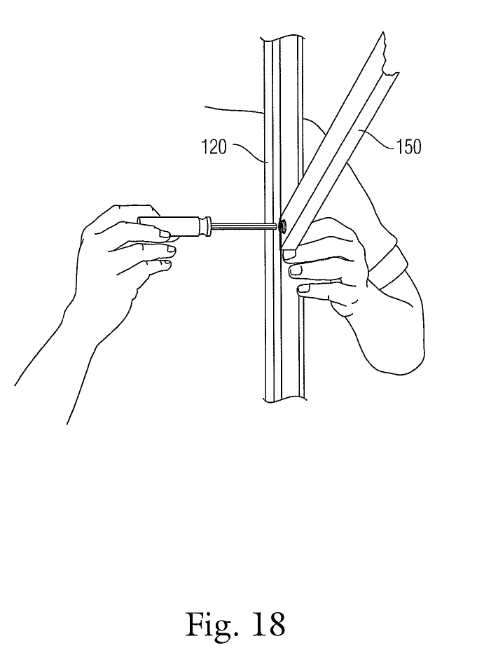

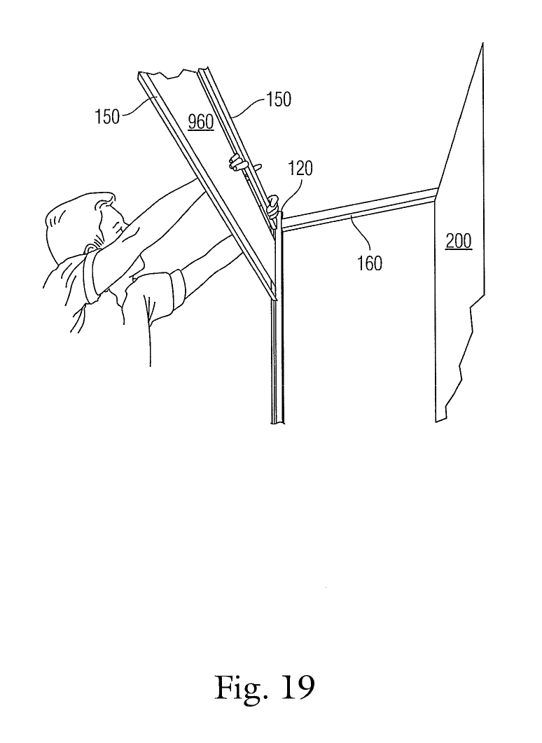

FIGS. 17 and 18 show the cross bars 150 being attached between the vertical supports 120, 122 using channel 144. Like the connector 160, the cross bars 150 have deployable locking members 400 disposed at each end thereof. The deployable locking members 400 are received into the channels 144 and are deployed to lock the cross bars 150 in place across the vertical supports 120, 122 in the front of the display 110. The graphic header 690 is received within the longitudinal slots 165 of the two opposing cross bars 150 in a manner similar to how graphic panel 675 is received and secured in place.

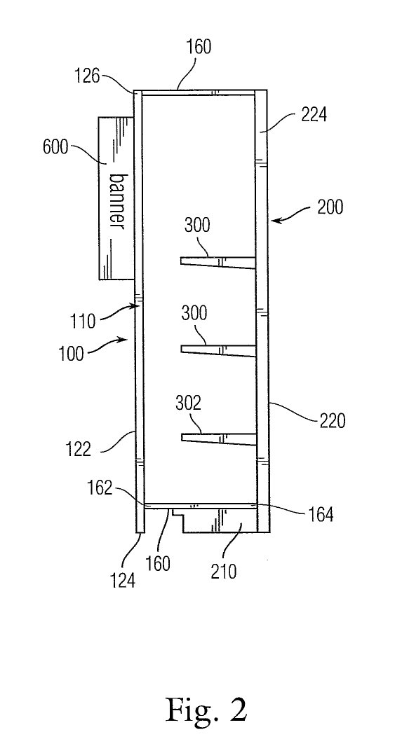

The aisle violator 600 can in the form of banner 600 as shown in FIG. 2 or a magnetic member as shown in FIG. 3 that receives magnetic signage.

Similar to how scaffolding is attached to an existing building front, the aisle violating display 100 is conveniently attached to an existing merchandise display 200. It will therefore be appreciated that the aisle violating display 100 is designed to be retrofittable to existing merchandise displays, such as a conventional shelving display 200.

It will also be appreciated that while the illustrated merchandise display 200 is in the form of upright shelving, the aisle violating display 100 can be attached to other types of upstanding merchandise displays so long as the frames of such displays are complementary to the aisle violating display 100 as described herein.

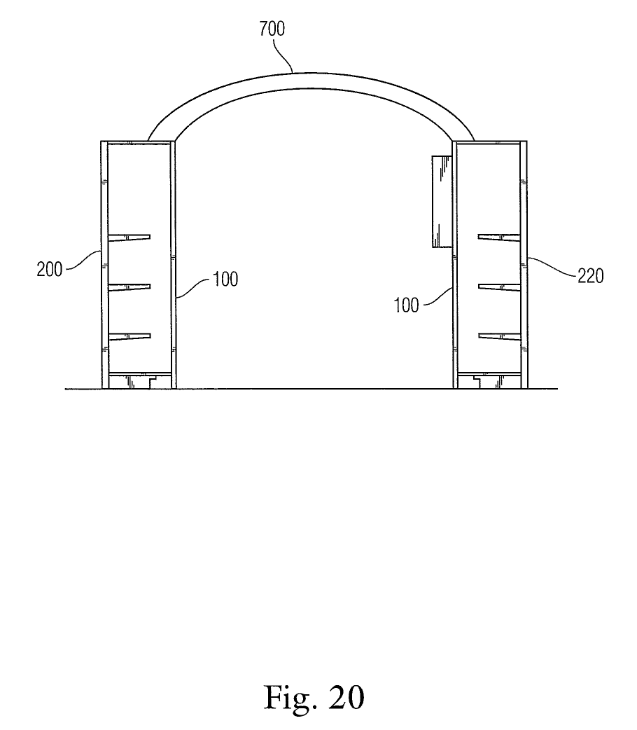

FIG. 20 shows another embodiment of the present invention in which a display bridge 700 is securely attached between two merchandise displays 200 and in particular, between two opposing aisle violating displays 100 that are opposite one another in an aisle. Product advertising and the like can be on the bridge 700.

It will be appreciated that the use of the deployable locking members 400 permits the display 100 to be easily mounted to existing shelving displays 200 that have perforated frames. While the method of attaching the two ends of the connectors 160 is similar, there are differences in terms of the structures that the locking members 400 are received in—one being a lipped channel in the support 120, 122 and the other being a standard opening in a perforated frame. However, in both, the deployed fingers are caught on the underside of the surrounding wall structures to provide secure attachment.

In another aspect of the present invention, the same male type connector, namely, the locking member 400 is used to engage two different types of frame structures and more particularly, two different types of female receiving slots or openings. In particular, the first and second parts 410, 420 which can be thought of as locking fingers the can be separated apart from one another upon actuation have a bent shape with the locking rib or ridge 423 formed at an end thereof. As shown in the drawings, the locking member is both configured to mate with the display frame 220 by being received within opening 130 and then being expanded from behind the front face of the slot wall (frame 220) to engage the shelving system near the fulcrum of the expanded connector parts 410, 420. On the aisle display side, however, the male component (first and second parts 410, 420) are expanded to laterally engage at the tips thereof, namely at the locking ridges 423 and be captured by the lip formed as part of the channel into which the parts 410, 420 are initially received in the non-deployed (collapsed) state.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. An aisle violator merchandise display assembly for attachment to an existing merchandise display having a perforated frame comprising:
first and second vertical support members, each vertical support member having a plurality of longitudinal channels formed therein and along a length thereof; each channel being defined by a lip having an underside surface, the first and second vertical supports being spaced apart from one another and parallel to one another;
at least one cross bar that is attached at its ends to the spaced vertical supports, each end of the cross bar having a deployable locking member in the form of a pair of locking fingers the distance between which can be varied by an actuator that is part of the cross bar, the locking fingers in a fully deployed position being locked within one channel and caught underneath the underside surface thereof; and
a plurality of connectors that are attached at their ends to one of the spaced vertical supports and to the perforated frame of the merchandise display, each end of the connector having a deployable locking member in the form of a pair of locking fingers the distance between which can be varied by an actuator that is part of the connector, the locking fingers at a first end of the connector in a fully deployed position being locked within one channel and caught underneath the underside surface thereof, the locking fingers at the other end for being captured within one opening formed in the perforated frame for attaching the aisle violator merchandise display assembly to the perforated frame.

2. A merchandise display comprising:
an upstanding shelving display including a frame with perforated vertical support members; and
an aisle violator merchandise display assembly for attachment to the shelving display, the aisle violator merchandise display assembly including:
first and second vertical support members, each vertical support member having a plurality of longitudinal channels formed therein and along a length thereof; each channel being defined by a lip having an underside surface, the first and second vertical supports being spaced apart from one another and parallel to one another;
at least one cross bar that is attached at its ends to the spaced vertical supports, each end of the cross bar having a deployable locking member in the form of a pair of locking fingers the distance between which can be varied by an actuator that is part of the cross bar, the locking fingers in a fully deployed position being locked within one channel and caught underneath the underside surface thereof; and
a plurality of connectors that are attached at their ends to one of the spaced vertical supports and to the perforated frame of the merchandise display, each end of the connector having a deployable locking member in the form of a pair of locking fingers the distance between which can be varied by an actuator that is part of the connector, the locking fingers at a first end of the connector in a fully deployed position being locked within one channel and caught underneath the underside surface thereof, the locking fingers at the other end for being captured within one opening formed in the perforated vertical support member for attaching the aisle violator merchandise display assembly to the upstanding shelving display.

3. A method for attaching an aisle violator merchandise display to an existing merchandise display in a retail aisle comprising the steps of:
(a) positioning a first vertical support of the aisle violator merchandise display in a front bottom corner of the existing merchandise display;
(b) attaching a connector between the vertical support and a perforated frame of the merchandise display a first bottom corner by first inserting a deployable locking member at a first end of the connector within an opening of the perforated frame and actuating the deployable locking member to cause deployment of a pair of locking fingers such that the locking fingers are captured within the opening by being seated against an adjacent underside wall surface of the perforated frame;
(c) inserting a deployable locking member at a second end of the connector within a longitudinal channel formed in the vertical support and actuating the deployable locking member to cause deployment of a pair of locking fingers such that the locking fingers are captured within the channel by being seated against an adjacent underside wall surface of the vertical support;
(d) attaching another connector between the first vertical support and a perforated frame of the merchandise display at a top corner in accordance with the steps (b) and (c);
(e) positioning a second vertical support of the aisle violator merchandise display in another front bottom corner of the existing merchandise display;
(f) attaching connectors between the second vertical support and a perforated frame of the merchandise display at both a bottom corner and a top corner in accordance with the steps (b) and (c); and
(g) attaching at least one horizontal cross bar between the first and second vertical supports in accordance with the steps (b) and (c) by deploying the locking members within channels formed in the first and second vertical supports.
